(19) United States
(12) Patent Application Publication
(10) Pub. No.: US 2011/0198544 A1
(43) Pub. Date: Aug. 18, 2011

(54) EMI Voltage Switchable Dielectric Materials Having Nanophase Materials

(76) Inventors: Lex Kosowsky, San Jose, CA (US); Robert Fleming, San Jose, CA (US); Junjun Wu, San Jose, CA (US); Thangamani Ranganathan, San Jose, CA (US)

(21) Appl. No.: 13/031,071

(22) Filed: Feb. 18, 2011

Related U.S. Application Data
(60) Provisional application No. 61/305,666, filed on Feb. 18, 2010.

(51) Int. Cl. H01B 1/12; H01B 3/00; H01B 1/02; B82Y 99/00

(52) U.S. Cl. 252/513; 252/500; 252/519.2; 252/521.3; 252/512; 977/785

(57) ABSTRACT

Various embodiments of the invention disclosed herein provide for adjusting the electrical response of a voltage switchable dielectric material by incorporating one or more nanophase materials. Various aspects provide for a VSDM having improved electrical and/or physical properties. In some cases, a VSDM may have improved (e.g., lower) leakage current at a given voltage. A VSDM may have improved resistance to ESD events, and may have improved resistance to degradation associated with protecting against an ESD event.

### CROSS-REFERENCE TO RELATED APPLICATIONS

This application claims priority to the U.S. provisional application titled “Voltage Switchable Dielectric Materials Having Nanophase Materials” having Ser. No. 61/305,666, filed Feb. 18, 2010, which is incorporated herein by reference in its entirety.

### BACKGROUND

1. Technical Field

The presently disclosed inventive concepts relate to voltage switchable dielectric materials, and more particularly to voltage switchable dielectric materials having nanophase materials.

2. Description of Related Art

Electrical and electronic components may benefit from surge protection, such as protection against electrostatic discharge (ESD) and other electrical events. Protection against ESD may include incorporating a voltage switchable dielectric material (VSDM). Generally, a VSDM may behave as an insulator at a low voltage, and behave as a conductor at a higher voltage.

A VSDM may be characterized by a so-called “switching voltage” below which the VSDM remains in a state of low conductivity and above which the VSDM moves to a state of high conductivity. A VSDM may provide a shunt to ground that protects a circuit and/or component against voltages above the switching voltage by allowing currents at these voltages to pass to ground through the VSDM, rather than through the circuit and/or component being protected.

Many VSDM materials are polymer-based, and may include filled polymers. A filled polymer may include particulate materials such as metals, semiconductors, ceramics, and the like. In many applications leakage current, which may be defined as a current passed through the VSDM under a low voltage, should be minimized.

In some cases, a VSDM may be degraded by an ESD event. Degradation may be manifested in electrical properties, such as an increase in leakage current. Degradation may also be manifest in physical properties such as strength, modulus, and the like.

### SUMMARY OF THE INVENTION

Various aspects provide for a voltage switchable dielectric material (VSDM). The VSDM may include an insulating phase (e.g., one or more polymers). The VSDM may further include a nanophase material (e.g., a Metal-Organic Framework (MOF) material, an isoreticular MOF material, and the like). The nanophase material may have a predetermined porosity. The nanophase material may have a predetermined structure (e.g., a zero-dimensional structure (nanoparticles), a one-dimensional structure (chains), a two-dimensional structure (sheets), or a three-dimensional structure (networks)). The nanophase material may have a predetermined shape (e.g., cuboctahedron, trigonal, tetrahedral, square, trigonal bipyramidal, octahedral, and the like).

In another aspect, a method for modifying an electrical response of a voltage switchable dielectric material (VSDM) is disclosed. The method can include the steps of selecting a VSDM material having an electrical response, and adding an effective amount of a nanophase material to the VSDM to thereby modify the electrical response of the VSDM.

### BRIEF DESCRIPTION OF THE DRAWINGS

FIG. 1A is a schematic illustration of an exemplary voltage switchable dielectric material (VSDM).

FIG. 1B is a schematic illustration of an “average” voltage drop across the VSDM of FIG. 1A.

FIG. 1C is a schematic illustration of a voltage drop across different phases of the VSDM of FIG. 1A.

FIG. 2 graphically illustrates varying degrees of degradation associated with an exemplary VSDM.

FIG. 3 is a schematic illustration of an exemplary voltage switchable dielectric material having nanophase materials.

FIG. 4 graphically illustrates an exemplary effect on post-event leakage current of incorporation of a nanophase material into a VSDM.

### DETAILED DESCRIPTION OF THE INVENTION

Various aspects of the present invention provide for a VSDM incorporating nanophase materials which give the material improved electrical and/or physical properties. In some cases, a VSDM may have improved (e.g., lower) leakage current at a given voltage. A VSDM may have improved resistance to ESD events, and may have improved resistance to degradation associated with protecting against an ESD event.

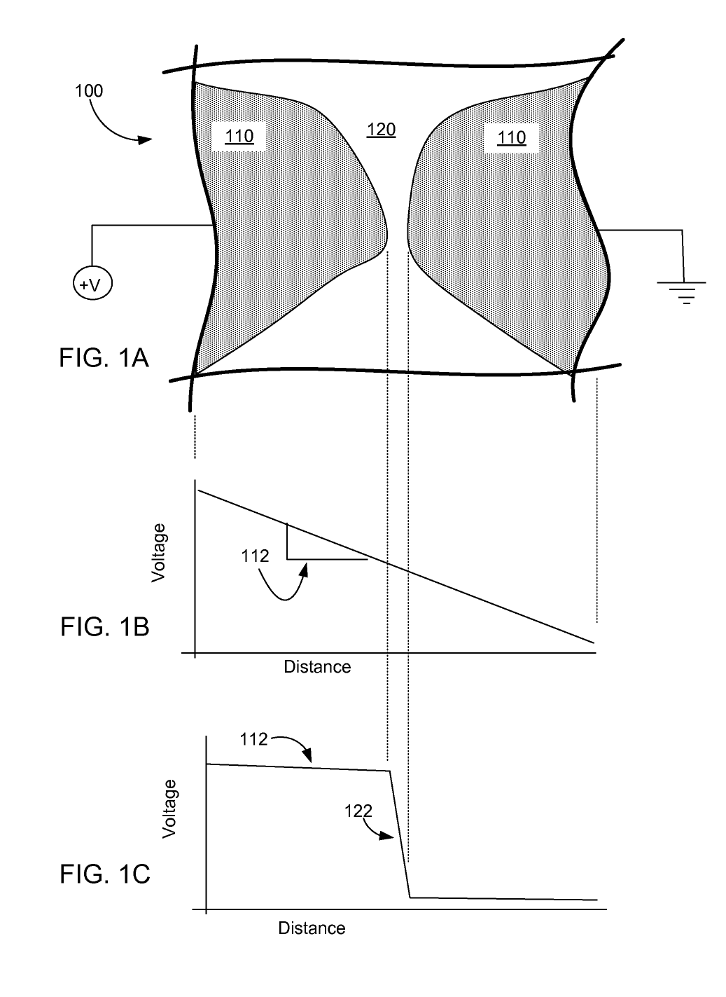

FIG. 1A illustrates an exemplary VSDM 100. VSDM 100 includes a conductive phase 110 and one or more insulating and/or semiconducting phases 120 (generically described as insulating phase 120). At low voltages, (e.g., voltages below a switching voltage, a trigger voltage, a clamp voltage, and the like), VSDM 100 may behave as an insulator. At higher voltages (e.g., voltages above the switching voltage, the trigger voltage, the clamp voltage, and the like), VSDM 100 may behave as a conductor. FIG. 1A also illustrates a hypothetical voltage difference across VSDM 100 (e.g., between an event voltage of several hundred volts and a ground).

FIG. 1B illustrates a schematic “average” voltage drop across VSDM 100. An average voltage drop may be determined by a voltage difference on either side of VSDM 100 and/or the overall thickness of VSDM 100 (i.e., the distance over which the voltage drops). An average electric field intensity 112 may be represented as shown in FIG. 1B

An electric field may not be uniform within a VSDM, such as VSDM 100. FIG. 1C illustrates a schematic representation of voltage drop across different phases 110 and 120 of VSDM 100. Voltage may drop a relatively small amount across conductive phases (e.g., conductive phase 110), and voltage may drop significantly across insulating and/or semiconducting phases (e.g., insulating phase 120).

In some cases, a relatively low electric field intensity 112 may be associated with a voltage drop across conductive phase 110, and a relatively high electric field intensity 122 may be associated with a potential drop across insulating phase 120. As a distance associated with insulating phase 120 decreases (e.g., as a gap between adjacent conductive phases 110 decreases), electric field intensities may be increasingly large. In some cases, electric field intensity 122 may be hundreds, thousands, millions, or even billions of times larger than an average electric field intensity 112.

Degradation may result from current passage through a material. Degradation may increase as field intensities increase, particularly when insulating phase 120 includes polymeric or other organic phases. Degradation may increase when conductive phase 110 includes less thermally stable materials, such as metals (particularly metals having lower melting points).

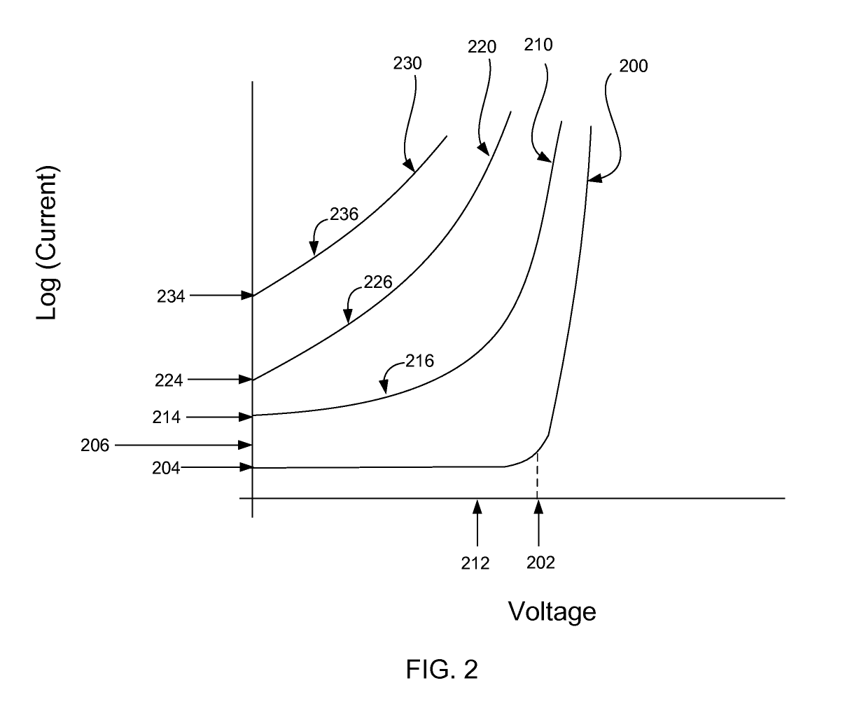

FIG. 2 illustrates certain aspects of degradation associated with a typical VSDM. FIG. 2 illustrates exemplary responses for a typical VSDM prior to an ESD event, after an ESD event, and after several ESD events. FIG. 2 illustrates four schematic electrical responses, each associated with a VSDM (or a material purported to be a VSDM). Response for VSDM 200 may describe an electrical response of a VSDM that has not been subject to an overvoltage event (e.g., an ESD event). Response for VSDM 210 may describe a response of a VSDM that has been subjected to a small number of ESD events (e.g., one) or an ESD event of relatively smaller voltage and/or current flow. Response for VSDM 220 may describe a response of a VSDM that has been subjected to a large number (e.g., several, greater than ten, greater than 100, greater than 1000, and the like) of ESD events, a high voltage ESD event, a high current ESD event, an ESD event having a voltage profile that is particularly damaging, and the like. Response 230 may describe a material having almost metallic electrical properties, which may be observed for some VSDM after very large events (e.g., an event large enough that metallic particles in the VSDM melt and fuse together).

VSDM 200 may be characterized by a first switching voltage 202. Switching voltage 202 may describe a voltage level (and/or a voltage difference over a thickness or distance of VSDM) below which the VSDM behaves as an insulator, and above which the VSDM behaves as a conductor (e.g., a few to tens of volts). In the exemplary response for VSDM 200, an off-state current 204 is associated with a maximum current passed by VSDM 200 at voltages below switching voltage 202. In this example, off-state current 204 may be below 1 microamp at 12 volts, which may be below a current-specification (e.g., 10 microamps at 12 volts), which may describe a maximum current that may be passed by a VSDM in an off-state (e.g., a leakage current maximum). In some cases, current flow in VSDM 200 at voltages below switching voltage 202 may be substantially independent of voltage.

VSDM 210 may be characterized by a switching voltage 212 that is different (e.g., lower) than that of VSDM 200. VSDM 210 may be characterized by a more “gradual” transition from insulating to conductive states (as compared to VSDM 200). In the exemplary response for VSDM 210, an off-state current 214 is associated with a maximum current passed by VSDM 210 at voltages below switching voltage 212. In this example, off-state current 214 may be tens of microamps at 12 volts, which may be above the current-specification. VSDM 210 may also include an off-state voltage response 216 that is different than that of VSDM 210. In some cases, off-state voltage response 216 may display an increasing current flow with increasing voltage (e.g., a partially ohmic response).

VSDM 220 may be characterized by an electrical response other than that signifying a typical switching voltage. In some cases, VSDM 220 may be characterized by a nonlinear (e.g., exponential) dependence of current on voltage. In the exemplary response for VSDM 220, an off-state current 224 is associated with a maximum current passed by VSDM 220 at various voltages. In this example, off-state current 224 may be of the order of milliamps, which may be above current-specification.

VSDM 230 may be characterized by an electrical response that approaches that of a metallic material. In some cases, VSDM 230 may be characterized by a relatively ohmic dependence of current on voltage. In the exemplary response for VSDM 230, an off-state current 234 is associated with a maximum current passed by VSDM 230 at various voltages. In this example, off-state current 234 is above current-specification 206, and may (for example) be above tens of milliamps at 12 volts.

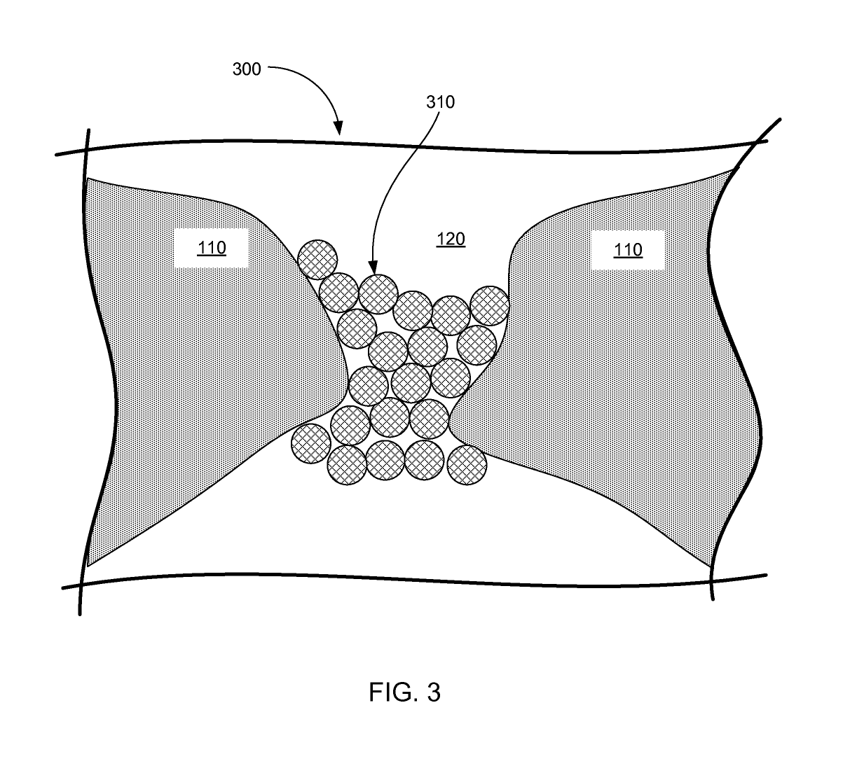

FIG. 3 illustrates a VSDM 300 incorporating (or including) a nanophase material 310, according to some embodiments. The nanophase material 310 may include a material having a porosity at a length scale from 0.1 to 1000 nanometers, and in some cases between 1 and 100 nanometers, and in some cases a porosity of a size that does not exceed 10 nm in any direction. The nanophase material 310 may include a material having a mean pore size from 0.1 to 1000 nm, including 1 to 100 nm, and/or from 4 to 80 nm. In some cases, the nanophase material 310 may include a substance “filling” the porosity. Porosity may be substantially open in some embodiments.

The nanophase material 310 may be a dielectric, a semiconductor, and/or a semimetal. The nanophase material 310 may include an inorganic material such as a zeolite and/or other framework structure. The nanophase material 310 may include a metal (e.g., Zinc, Aluminum, Copper, Iron, transition metals, rare earth metals, alkaline earth metals, and the like). The nanophase material 310 may include organic species (e.g., organic molecules), which may be bound to a metal in certain cases. The nanophase material 310 may include a region having metallic properties and a region having insulating and/or semiconducting properties.

In certain cases, the nanophase material 310 may include a metal-organic-framework (MOF) material, such as a carboxylate, an imidazole, and the like, or other framework material. The framework material may have a predetermined structure, e.g., a zero-dimensional structure (nanoparticles), a one-dimensional structure (chains), a two-dimensional structure (sheets), or a three-dimensional structure (networks).

The nanophase material 310 may have a predetermined shape (e.g., cuboctahedron, trigonal, tetrahedral, square, trigonal bipyramidal, octahedral, and the like).

The nanophase material 310 may include a high surface area phase such as a high surface area silicate, aluminate, and the like. The nanophase material 310 may have a BET surface area above 700 m²/g, above 1000 m²/g, above 2000 m²/g, and/or above 4000 m²/g. The nanophase material 310 may include substantially equiaxed pores (e.g., substantially “spherical” pores). The nanophase material 310 may include substantially ellipsoidal pores. The nanophase material 310 may include a particulate material, and may include nanoparticles having open porosity.

The nanophase material 310 may be inorganic, metal-organic, and/or a composite material. The nanophase material 310 may include a semiconductor and/or an insulator. Certain of the nanophase materials 310 may include a metal and an organic component. The nanophase material 310 may include any of a group 11, 12, 13, 14, and/or 15 element. The nanophase material 310 may include any of Cu, Ag, Au, Zn, Cd, Hg, B, Al, Ga, In, C, Si, Ge, Sn, Pb, P, As, Sb, Bi, Se, and Te.

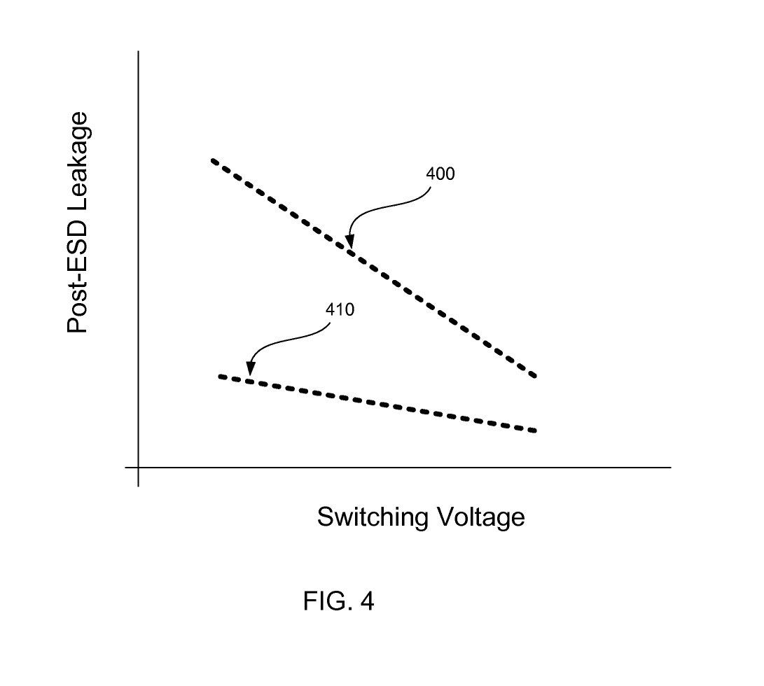

FIG. 4 illustrates an exemplary effect of the incorporation of a nanophase material (e.g., nanophase material 310) on post-event leakage current, according to some embodiments. FIG. 4 illustrates two electrical responses, each describing a relationship between switching voltage and leakage current for a VSDM after having responded to an ESD event (e.g., having transitioned from insulating to conducting and back). FIG. 4 illustrates responses for two families of VSDM samples. A family of VSDM samples may be related (e.g., may have substantially similar composition), but differ by amounts of each phase.

A plurality of different materials in a first family of VSDM may be characterized by a first relationship 400 between leakage current and switching voltage. In this example, the switching voltage may be adjusted (raised or lowered) by adjusting a composition of VSDM in the family. The composition may be adjusted, for example, by increasing or decreasing a volume of conductive particles in the insulating polymer matrix. Increasing an amount of conductive particles may decrease the trigger voltage, but may also increase an observed leakage current.

A second relationship 410 between leakage current and switching voltage of a second family of VSDM is also illustrated in FIG. 4. The second relationship 410 illustrates an effect of incorporating a nanophase material into the first family of VSDM associated with relationship 400. In some aspects, incorporation of the nanophase material may decrease leakage current at a particular switching voltage. Incorporation of the nanophase material may reduce the switching voltage of the VSDM at a particular specification for leakage current. In some cases, the relationship between leakage current and switching voltage may be changed by incorporating the nanophase material into the VSDM. In the example shown in FIG. 4, relationship 410 is characterized by a reduced slope as compared to relationship 400.

Turning now to a more particular embodiment of the application or incorporation of a nanophase material into a VSDM, the following is provided by way of example only. The following example is not intended to be limiting, in any manner, of the presently disclosed inventive concepts. More particularly, changes to the example described below as well as the description above are considered within the scope of the present disclosure.

### Example 1

### Materials

All the chemicals were used as received and are listed below with the manufacturer in parentheses: Carbon nanotubes (Cheap Tubes), EPON 828 (Hexion Chemicals), GP611 (Genesee Polymers), Dyhard T03 (Degussa), 1-Methyl imidazole and N-methyl pyrrolidinone (Alfa Aeser), Basolite Z1200 (Sigma Aldrich), DISPERBYK145 (BYK), ZnO (Nanophase), antimony doped stannous oxide, CPM08F (Keeling & Walker) and TiO₂, TIPAQUE CR-50-2 (Ishihara).

Formulation:

In a typical procedure, 0.2 vol % of short graphitized multiwall carbon nanotubes (>50 nm) was added to the resin mixture (1:1 weight ratio) of EPON828 (bisphenol A epoxy) and GP611 (epoxy-functionalized siloxane). To this were added one equivalent of curative, dicyanamide (Dyhard T03) in the form 15 wt % solution in NMP (N-Methyl-2-pyrrolidone), 0.3 vol % of catalyst (1-methyl imidazole) and 0.4 vol % of dispersant (DISPERBYK145). About 5 wt % with respect to the resin of metal-organic framework (MOF) material, specifically, Zinc-imidazolate (Basolite, Z1200) was added in one of the formulation (Example 2). Minimum required amount of NMP was then added to get a homogenous solution. The mixture was stirred and sonicated for about 1 hr to ensure uniform dispersion of the carbon nanotubes into the resin system. Then, a mixture of semi-conductors, antimony doped stannous oxide, STANOSTAT CPM08F (9 vol %), zinc oxide, NanoTek (7 vol %) and titanium dioxide, TIPAQUE CR-50-2 (5 vol %) were added with continued sonication and stirring for 30 minutes. Sonication was then stopped and a mixture of two nickel types (varying size), Novamet-4SP-10 (18 vol %) and JFE-401S (6 vol %) were added and further stirred for 1 hr. The mixture was then uniformly mixed for 40 hours using a rotor-stator mixer with sonication. The resulting mixture was applied as a coating using #40 wire rod across a 2.5 mil or 3 mil gap between two electrodes. This was followed by a curing process which includes a continuous heating sequence of 75° C. for 10 mins, 125° C. for 10 mins, 175° C. for 45 mins, and 200° C. for 1 hr.

Characterizing the Dynamic ESD Response

A variety of pulse generators are used to characterize the dynamic voltage, current, and resistance responses. These pulse generators can be grouped into three broad categories, depending on the focus of the test.

When the focus is on how materials behave in a finished hand-held product, the tests are based on the test methodologies outlined in the IEC 61000-4-2 and EN 61000-4-2 test standards. For these tests, the pulse generators are usually commercially available ESD guns that conform to the technical specifications outlined in the two standards. The energy storage component in the ESD guns is a 150 pF capacitor. The series discharge resistance is 330 ohms. Capacitor charging voltages range from 2 to 16 thousand volts.

When the focus is on how materials behave in a manufacturing environment or a chip substrate, the pulse generators are typically based on the Human Body Model (HBM) outlined in standards such as JEDEC JESD22-A114 and ANSI/ESD STM5.1-2007. The energy storage component for a pulse generator that conforms to these standards is a 100 pF capacitor. The series discharge resistance is 1500 ohms. Capacitor charging voltages range from several hundred volts to several thousand volts.

When the focus is on the mechanics/physics of how materials switch on and off, the tests are usually based on Transmission Line Pulse (TLP) generators such as those specified in the ANSI/ESD standards SP5.5.2-2007 and STM5.5.1-2008. The pulse waveforms for both the IEC/EN and JEDEC/ANSI test standards vary with time, and so the process of separating (de-embedding) the VSD™ dynamic response from the time-varying pulse becomes difficult.

TLP generators, on the other hand, generate a clean rectangular pulse whose output voltage stays constant for the duration of the pulse, greatly simplifying the extraction of the dynamic voltage, current, and resistance responses of materials to a fast-edged ESD-like pulse. The energy storage component in a TLP pulse is the capacitance of a finite length of coaxial transmission line. The length of rectangular pulse is proportional to the length of the transmission line that is charged. Typical pulse widths range from 10-100 nanoseconds. The series discharge resistance of a TLP is equal to the characteristic impedance of the coaxial transmission line—typically 50 ohms. Charging voltages can range from several hundred volts to several thousand volts.

Table 1 below illustrates the formulation composition and electrical results of the above-described example.

TABLE 1
Formulation composition and electrical results

| | Example 1 | | | | Example 2 | | | |
|---|---|---|---|---|---|---|---|---|
| Material | Weight (g) | | | | Weight (g) | | | |
| Short graphitized CNT | 0.96 | | | | 0.96 | | | |
| Zinc-imidazolate (MOF) | 0 | | | | 8.36 | | | |
| EPON828 | 78 | | | | 74 | | | |
| GP611 | 78 | | | | 74 | | | |
| Degussa Dyhard T03 | 10.97 | | | | 10.4 | | | |
| 1-Methyl imidazole | 0.8 | | | | 0.8 | | | |
| DISPERBYK145 | 1.1 | | | | 1.1 | | | |
| ZnO (NanoTek) | 89.3 | | | | 89.9 | | | |
| ATO (STANOSTAT | 155.5 | | | | 156.5 | | | |
| CPM08F) | | | | | | | | |
| TiO2 (CR-50-2) | 55.8 | | | | 56.2 | | | |
| Nickel (Novamet 4SP-10) | 426 | | | | 428.5 | | | |
| Nickel (JFE-401S) | 142 | | | | 142.8 | | | |
| N-methyl pyrrolidinone | 112.2 | | | | 119 | | | |
| Gap | 2.5 | mil | 3 | mil | 2.5 | mil | 3 | mil |
| Trigger voltage | 332 ± 10 | V | 340 ± 1 | V | 232 ± 6 | V | 264 ± 5 | V |
| Clamp voltage | 200 ± 2 | V | 240 ± 6 | V | 186 ± 4 | V | 224 ± 4 | V |
| 10 ns Clamp voltage | 267 ± 8 | V | 304 ± 12 | V | 211 ± 4 | V | 244 ± 6 | V |

| | | |
|---|---|---|
| BSD shorts: <10 kΩ | 0% (4 kV); 2% (2 kV) | 1% (4 kV); 2% (2 kV) |
| BSD pass: >1 MΩ | 94% (4 kV); 92% (2 kV) | 89% (4 kV); 92% (2 kV) |

Some embodiments include sensors to sense various parameters (e.g., current, voltage, power, distance, thickness, strain, temperature, stress, viscosity, concentration, depth, length, width, switching voltage and/or voltage density (between insulating and conducting), trigger voltage, clamp voltage, off-state current passage, dielectric constant, time, date, and other characteristics). Various apparatus may monitor various sensors, and systems may be actuated by automated controls (solenoid, pneumatic, piezoelectric, and the like).

Some embodiments include a computer readable storage medium coupled to a processor and memory. Executable instructions stored on the computer readable storage medium may be executed by the processor to perform various methods described herein. Sensors and actuators may be coupled to the processor, providing input and receiving instructions associated with various methods. Certain instructions provide for closed-loop control of various parameters via coupled sensors providing input and coupled actuators receiving instructions to adjust parameters. Certain embodiments include materials. Various embodiments include telephones (e.g., cell phones), USB-devices (e.g., a USB-storage device), personal digital assistants, laptop computers, netbook computers, tablet PC computers, and the like.

The embodiments discussed herein are illustrative of the presently disclosed inventive concepts. As these embodiments are described with reference to illustrations, various modifications or adaptations of the methods and/or specific structures described may become apparent to those skilled in the art. All such modifications, adaptations, or variations that rely upon the teachings of the present disclosure, and through which these teachings have advanced the art, are considered to be within the spirit and scope of the present disclosure. Hence, these descriptions and drawings should not be considered in a limiting sense, as it is understood that the present disclosure is in no way limited to only the embodiments illustrated.

What is claimed is:

1. A voltage switchable dielectric material (VSDM) comprising:
a conductive phase;
an insulating phase; and
a nanophase material that modifies an electrical response of the VSDM.

2. The VSDM of claim 1, wherein the nanophase material includes a semiconducting phase.

3. The VSDM of claim 1, wherein the nanophase material includes an insulating phase.

4. The VSDM of claim 1, wherein the nanophase material includes a Metal Organic Framework (MOF) material.

5. The VSDM of claim 4, wherein the MOF material is at least one of a carboxylate, a Zinc-imidazolate, and an imidazole.

6. The VSDM of claim 1, wherein the nanophase material includes a covalent organic framework material.

7. The VSDM of claim 1, wherein the nanophase material includes a zeolitic imidazolate framework material.

8. The VSDM of claim 1, wherein the nanophase material includes at least one of a terephthalate, a zeolite, an aluminum, an imidazole, a zinc, a copper, and an iron.

9. The VSDM of claim 1, wherein the nanophase material includes a surface area greater than 1,000 m²/g.

10. The VSDM of claim 1, wherein the nanophase material includes a surface area greater than 2,000 m²/g.

11. The VSDM of claim 1, wherein the nanophase material includes a surface area greater than 4,000 m²/g.

12. The VSDM of claim 1, wherein the predetermined porosity of the nanophase material does not exceed 100 nm.

13. The VSDM of claim 1, wherein the predetermined porosity of the nanophase material does not exceed 30 nm.

14. The VSDM of claim 1, wherein the predetermined porosity of the nanophase material does not exceed 10 nm.

15. The VSDM of claim 1, wherein the predetermined porosity of the nanophase material does not exceed 6 nm.

16. A method for modifying an electrical response of a voltage switchable dielectric material (VSDM), the method comprising:
selecting a VSDM material having an electrical response; and
adding a nanophase material to the VSDM to modify the electrical response of the VSDM.

17. The method of claim 16, wherein the amount of the nanophase material added is between 0.01 and 40%.

18. The method of claim 16, wherein the amount of the nanophase material added is between 0.1 and 10%.

19. The method of claim 16, wherein the amount of the nanophase material added is 5.0%.

20. The method of claim 16, wherein the electrical response of the VSDM is a first trigger voltage at a first leakage current and the effective amount of nanophase material reduces the first trigger voltage by 30% at the first leakage current.
